(19) United States
(12) Patent Application Publication
(10) Pub. No.: US 2014/0013338 A1
(43) Pub. Date: Jan. 9, 2014

(54) EXTENSIONS TO BUSINESS TO BUSINESS MESSAGES FOR EXTERNAL COMMUNICATION

(71) Applicants: Roland Brechter, St. Leon-Rot (DE); Johann Kemmer, Muehlhausen (DE); Thomas Walter, Muehlhausen (DE)

(72) Inventors: Roland Brechter, St. Leon-Rot (DE); Johann Kemmer, Muehlhausen (DE); Thomas Walter, Muehlhausen (DE)

(73) Assignee: SAP AG, Walldorf (DE)

(21) Appl. No.: 13/542,383

(22) Filed: Jul. 5, 2012

(51) Int. Cl. G06F 13/00

(52) U.S. Cl. 719/315

(57) ABSTRACT

An integrated development environment may be displayed on a display device. The integrated development environment may include functionality to add extension field(s) to business objects included in a business scenario. One or more of the business objects may be in a first system. In response to input indicating extension field(s), the extension field(s) may be added to business object(s) in the first system. A message may be sent from the first system to a second system. The message may include information associated with the extension field(s).

### BACKGROUND

Business software such as enterprise resource planning (ERP) software implements business processes by modeling business data as business objects (BOs) with data exchange between the BOs. The business data provided via BOs can be accessed through mechanisms such as user interfaces, forms, and analytical reports.

Traditionally, Business to Business (B2B) communication only allows for a standard way to exchange information between multiple systems in general. However, there is a need to efficiently extend standard B2B messages.

### BRIEF DESCRIPTION OF THE DRAWINGS

FIG. 1 illustrates a business scenario according to an embodiment.

FIG. 2 illustrates a graphical user interface (GUI) to search for extendable business scenarios according to an embodiment.

FIG. 3 illustrates a GUI to identify BO(s) to extend from a extendable business scenario according to an embodiment.

FIG. 4 illustrates an integrated development environment (IDE) to extend business scenario(s).

FIG. 5 shows an exemplary architecture in an embodiment.

FIG. 6 illustrates a business scenario according to an embodiment.

FIG. 7 illustrates propagation of an extension field to BOs according to an embodiment.

### DETAILED DESCRIPTION

Embodiments may be discussed in systems to efficiently communicate BO related information across multiple systems. In an embodiment, an integrated development environment may be displayed on a display device. The integrated development environment may include functionality to add extension field(s) to business objects included in a business scenario. One or more of the business objects may be in a first system. In response to input indicating extension field(s), the extension field(s) may be added to business object(s) in the first system. A message may be sent from the first system to a second system. The message may include information associated with the extension field(s).

In an embodiment, the first system and the second system may be business software. In an embodiment, business object(s) in the first system may be an inbound service and/or an outbound service. In an embodiment, the first system and the second system may communicate through a predefined protocol. In an embodiment, the predefined protocol may be hyper text transfer protocol (HTTP). In an embodiment, in response to the sent message, a value associated with a business object in the second system may be modified.

Business software usually includes a standard set of BOs which can be utilized by the software user. For example, in an embodiment, business software may include BOs representing sales orders, sales quotes, customer quotes, service documents, and business opportunities. Each BO may include attributes and/or other BOs predefined by the software provider, and may be referred to as nodes. For example, a business opportunity BO may include one or more business process variant types, business transaction documents, overviews, parties, sales and service business areas, sales cycles, sales cycle assistants, and sales forecasts. Here, business process variant types, business transaction documents, overviews, parties, sales and service business areas, sales cycles, sales cycle assistants, and sales forecasts may be referred to as nodes of the business opportunity BO.

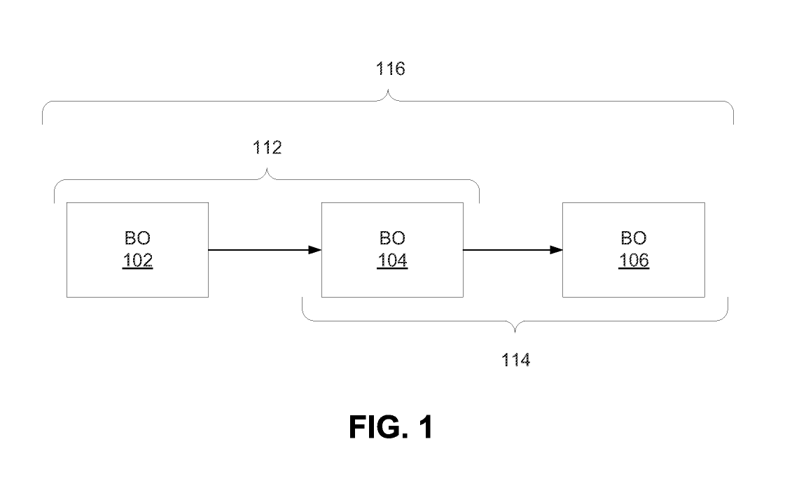

FIG. 1 illustrates a business scenario according to an embodiment. Business software consumers may create predefined BOs (and/or instances of predefined BOs), assign values to the created BOs, and link the BOs to model one or more business scenarios. For example, in an embodiment, BO 102 may be a business opportunity. This BO may include details such as the parties involved in the business opportunity such as the vendor, a prospective client, and a product being pitched to the prospective client. The business opportunity may result in the prospective client asking for a sales quote, which may be represented in the business software by BO 104. The information in the business opportunity BO 102 may be communicated to the sales quote BO 104. In an embodiment, the communication between BOs may occur through one or more function calls. In an embodiment, the communication between BOs may occur via one or more messages sent from one BO to another BO. In an embodiment, the information about the vendor, the prospective client, and the product may be copied from the business opportunity BO 102 to the sales quote BO 104. The communication of data between one BO to another may be called a data flow. For example, the communication of data between BO 102 and BO 104 may be data flow 112.

In an embodiment, after a sales quote is received by a prospective client, the prospective client may place a sales order based on the quote. The sales order may be represented by BO 106. There may be a data flow 114 between the sales quote BO 104 and the sales order BO 106. In an embodiment, the information about the vendor, the client, and the product may be copied from the sales quote BO 104 to the sales order BO 106. The communication chain of data between one or more BOs may be called a business scenario. In an embodiment, a business scenario may not have a communication gap between BOs in the business scenario. In other words, a business scenario may be one or more data flows without any communication gaps between the BOs of the data flows. Thus, data flow 112 may be a business scenario, data flow 114 may be a business scenario, and the combination 116 of data flows 112 and 114 may be a business scenario.

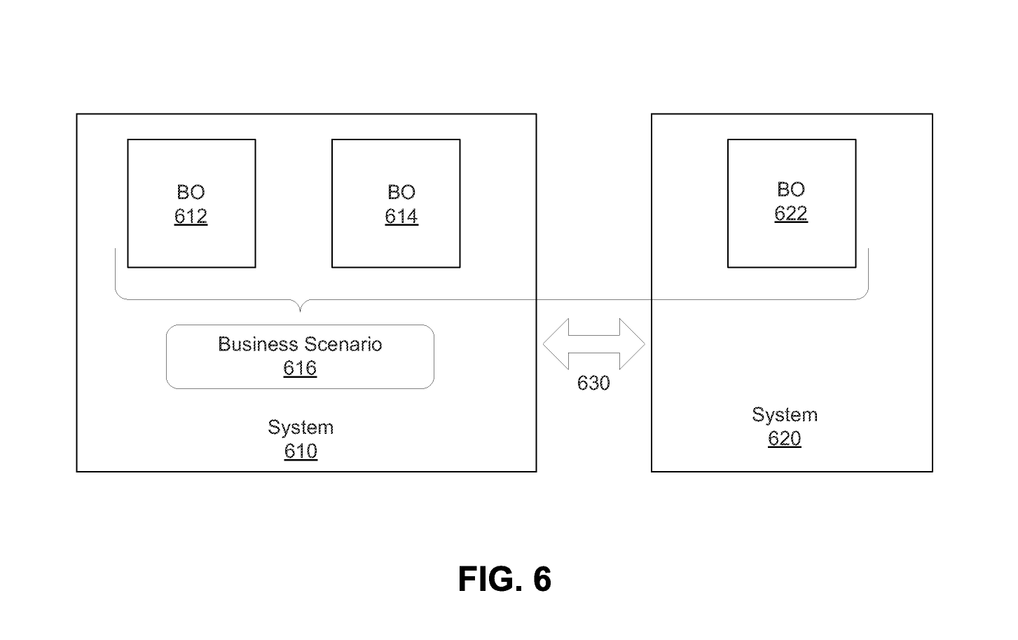

FIG. 6 illustrates a business scenario according to an embodiment. In an embodiment, multiple systems 610 and 620 may include BOs. The BOs from one system may communicate with BOs from another system via a communication protocol 630. There may be a communication chain between BOs 612, 614, and 622 of multiple systems 610 and 620. Thus, BOs 612, 614, and 622 from multiple systems 610 and 620 may belong to a single business scenario 616. In an embodiment, the business scenario 616 may belong to a particular system 610.

In an embodiment, the systems 610 and 620 may represent different software applications running on a single computer. In another embodiment, the systems 610 and 620 may represent different software applications running on separate computers such as two separate computer servers. The communication link 630 between systems 610 and 620 may include any communication protocol including hyper text transfer protocol (HTTP), file transfer protocol (FTP), and real time streaming protocol (RTSP).

In an example embodiment, the system 610 may be a business software application which models the processes within a business organization, and the system 620 may be a business software application dedicated to keep track of sales orders. BO 612 may be a business opportunity BO, BO 614 may be a sales quote BO, and BO 622 may be a sales order BO. This business opportunity BO 612 may be a software object instantiated in the business software application 610, and may include details such as the parties involved in the business opportunity such as the vendor, a prospective client, and a product being pitched to the prospective client. The business opportunity may result in the prospective client asking for a sales quote, which may be represented in the business software by the BO 614. This sales quote BO 614 may be a software object instantiated in the business software application 610. The information in the business opportunity BO 612 may be communicated to the sales quote BO 614. In an embodiment, the communication between BO 612 and BO 614 may occur through one or more function calls. In an embodiment, the information about the vendor, the prospective client, and the product may be copied from the business opportunity BO 612 to the sales quote BO 614.

In an embodiment, after a sales quote is received by a prospective client, the prospective client may place a sales order based on the quote. The sales order may be represented by BO 622. The sales order BO 622 may be a software object instantiated in the business software application 620. In an embodiment, the information about the vendor, the client, and the product may be copied from the sales quote BO 614 to the sales order BO 622. In an embodiment, the communication between BO 614 may occur via one or more messages sent from the sales quote BO 614 to the sales order BO 622 using a communication protocol such as HTTP. The communication chain of data between the BOs 612, 614, and 622 may be business scenario 616. The business scenario 616 may be a software object instantiated in the business software application 610.

Although the above example embodiment portrays BO 622 as an outbound service, i.e., a BO which receives data from another system 610, in other embodiments, BO 622 may be an inbound service. That is, data from BO 622 may flow into a BO in another system 610.

In an example embodiment, the system 610 may be software and may be created by a software provider. The system 620 may be a software created by a third party such as a software partner to be utilized in conjunction with the software 610 by an ultimate business software consumer. For example, in an embodiment, a business software consumer such as an automobile seller may be interested in purchasing business software to model the consumer's business. A software provider may provide business software 610 with generic BOs to a partner specializing in the automobile industry. The business software 610 with generic BOs may include a generic sales quote BO 614. The generic sales quote BO 614 may include a field to specify a type of product such as a car. However, the generic sales quote BO 614 may not allow for enough granularity to specify the exact make and model of the car. Therefore, a software partner who specializes in the automobile industry may provide a second software 620 which incorporates automobile industry specific logic. The second software may provide the functionality to specify the exact make and model of the car.

Traditionally, Business to Business (B2B) communication only allows for a standard way to exchange information between multiple systems in general. However, there is a need to efficiently extend standard B2B messages.

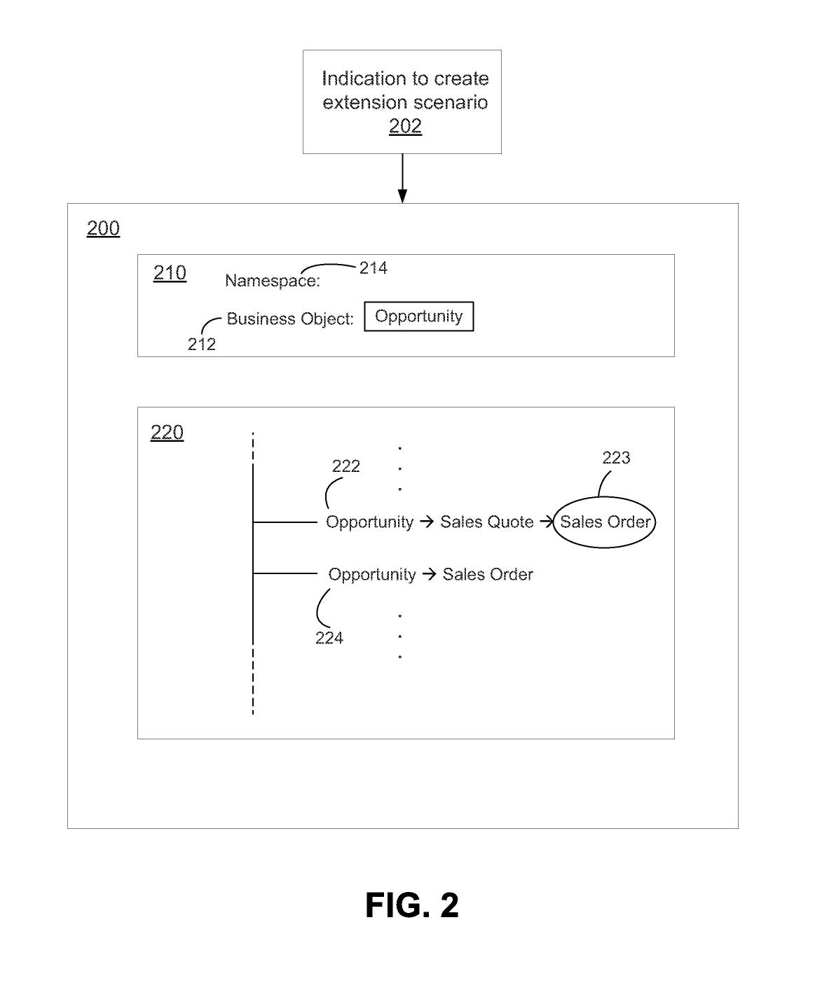

In an embodiment, a graphical user interface (GUI) may be utilized by a user (such as a partner) to extend business scenarios. FIG. 2 illustrates a GUI to search for extendable business scenarios according to an embodiment. In response to an indication to create a new business scenario extension 202, a GUI such as the GUI 200 may be displayed. The GUI 200 may be a GUI to search for existing business scenarios which can be extended. The GUI 200 may include a first area 210 to specify search parameters for existing business scenarios. The GUI may include a second area 220 to display business scenario(s) matching the search parameters specified in the search area 210.

In an embodiment, the search area 210 may include parameter fields such as a namespace field 214 and/or a BO field 212. In an embodiment, specifying a particular BO, for example “opportunity,” in the BO field 212 and searching for available business scenarios may display, in display area 220, the available business scenarios which include the BO opportunity (222 and 224). One or more of the displayed business scenarios may be selected and marked as a business scenario to be extended, for example via check boxes next to the business scenarios, highlighting, etc.

In an embodiment, selecting one or more business scenarios may display available business scenarios related to the selected business scenario(s). In an example embodiment, since the business scenario 222 includes the three BOs, opportunity, sales quote, and sales order, selecting business scenario 222 may display all business scenarios which include any one of the three BOs. In an embodiment, the BOs belonging to business scenario 222 may be part of different systems as explained above with regards to FIG. 6. For example, the sales order BO 223 may be part of a different system than the opportunity and sales quote BOs.

In an embodiment, the search area 210 may include parameter fields such as a business scenario field (not shown) and/or a data flow field (not shown) so that the available business scenarios may be searched based on business scenario identifiers and/or data flow identifiers respectively. A person having ordinary skill in the art will appreciate that any search criteria capable of identifying business scenarios may be displayed in search area 210.

In an embodiment, the available values for the search fields displayed in search area 210 may be shown via a pre-populated drop down menu. In an embodiment, the values for the search fields may be typed in manually as a text string.

In an embodiment, the search area 210 may include a field (not shown) to input a text string search query similar to a structured query language (SQL) query. For example, the search query, “select business_scenario where business_object=‘opportunity’”, may display in display area 220 the available business scenarios which include the BO opportunity (222 and 224). A person having ordinary skill in the art will appreciate that the exact syntax of the text search string may vary in other embodiments.

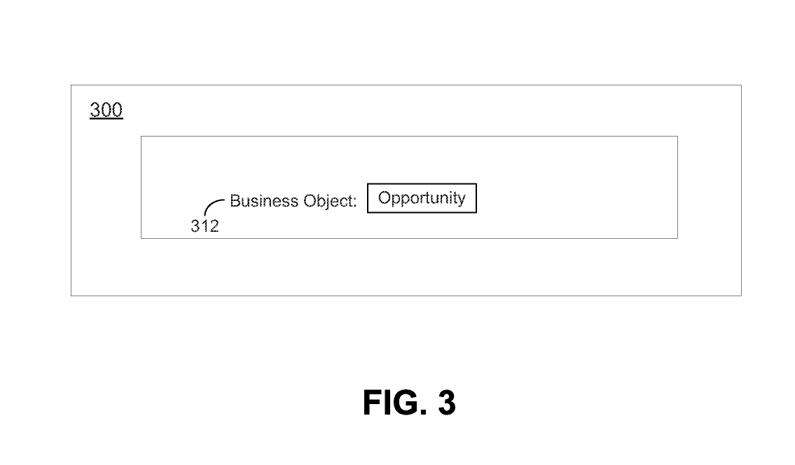

FIG. 3 illustrates a GUI to identify BO(s) to extend from a extendable business scenario according to an embodiment. In an embodiment, after identifying the business scenario(s) which the user wants to extend (for example, by utilizing a GUI such as the one discussed in FIG. 2), the user may be presented with a GUI 300 to identify BO(s) to extend from the identified business scenarios. The GUI 300 may include a BO field 312 to specify one or more BOs.

In an embodiment, the BO field 312 may list the BOs included in a business scenario previously identified for extension. For example, in an embodiment, the user may use GUI 200 (FIG. 2) to identify that he/she wishes to extend business scenario 222. As seen in FIG. 2, business scenario 222 includes three BOs: opportunity, sales quote, and sales order. Consequently, the field 312 may be pre-populated with the same three BOs: opportunity, sales quote, and sales order. The user may then identify one or more of the three BOs to extend. In an embodiment the field 312 may include a drop down menu, a drop down list, a static list, radio buttons, check boxes, or any such mechanism which is capable of displaying BOs and allows for selection of one or more BOs.

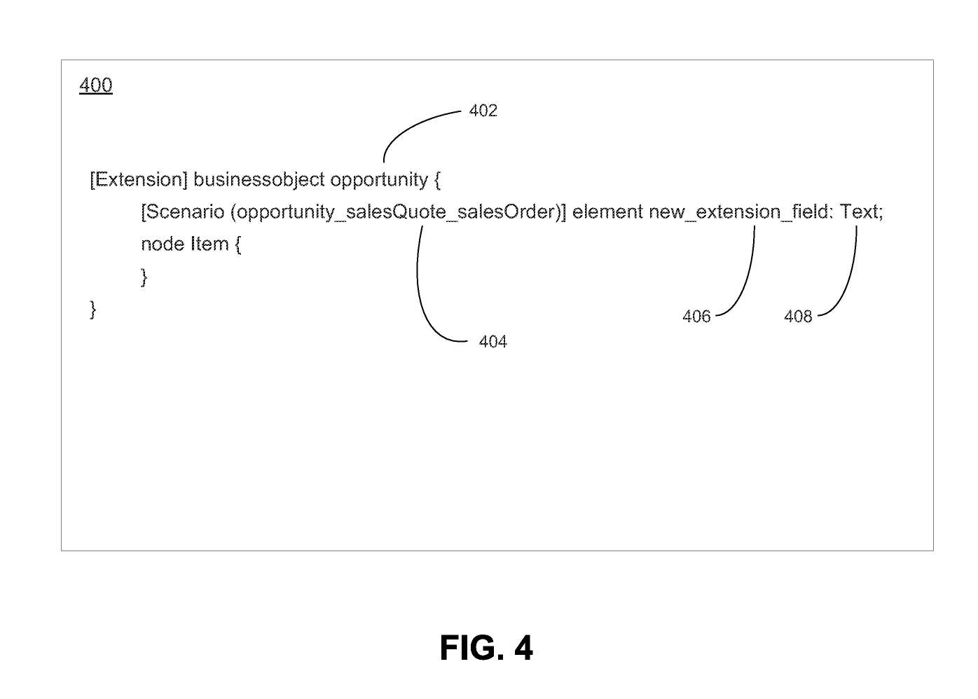

FIG. 4 illustrates an integrated development environment (IDE) to extend business scenario(s). In an embodiment, after identifying the business scenario(s) which the user wants to extend (for example, by utilizing a GUI such as the one discussed in FIG. 2), and identifying corresponding BO(s) from the business scenario(s) (for example, by utilizing a GUI such as the one discussed in FIG. 3), the user may be presented with an IDE 400 to create one or more new extension fields for the identified BO(s) associated with the business scenario(s).

In an embodiment, the IDE may be pre-populated with programming code necessary to add one or more new extension fields. For example, in an embodiment, the user may use GUI 200 (FIG. 2) to identify that he/she wishes to extend business scenario 222. As seen in FIG. 2, business scenario 222 includes three BOs: opportunity, sales quote, and sales order. In an embodiment, the user may use GUI 300 (FIG. 3) to identify that he/she wishes to extend the BO, opportunity. As a result, the IDE 400 may be automatically populated with programming code which includes instructions to extend the BO opportunity 402 (previously selected using GUI 300) belonging to the business scenario opportunity_salesQuote_salesOrder 404 (previously selected using GUI 200). The user may then specify the name of the new field being added and the data type of that new field. For example, in an embodiment, the user may add a new extension field called new_extension_field 406 of a text data type 408.

A person having ordinary skill in the art will appreciate that the programming language shown in IDE 400 is an example embodiment, and that other embodiments may incorporate any programming language including advanced business application programming (ABAP), C++, Java, C, C#, and Visual Basic. Similarly, a person having ordinary skill in the art will appreciate that an extension field can be of any data type, including, integer, floating point number, packed number, text, date, numeric text, time, hexadecimal, object (such as an object oriented object), and BO.

In an embodiment, once the user specifies the new extension field(s) and the corresponding data type(s) of the extension fields, the associated BO(s) will include the new extension field(s), and the user may have access to the newly defined extension field within the business software. For example, after defining the new field as described above using IDE 400, the BO opportunity, belonging to the business scenario, opportunity→sales quot→sales order, will include a new extension field of text data type, and the user may assign values to the new extension field.

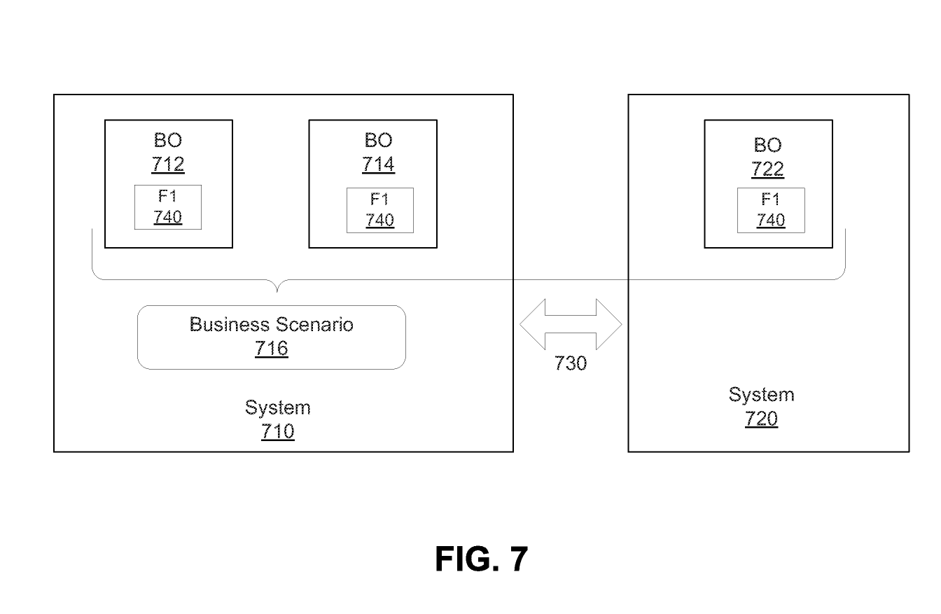

FIG. 7 illustrates propagation of an extension field to BOs according to an embodiment. In an embodiment, multiple systems 710 and 720 may include BOs. The BOs from one system may communicate with BOs from another system via a communication protocol 730. There may be a communication chain between BOs 712, 714, and 722 of multiple systems 710 and 720. BOs 712, 714, and outbound messages belonging to BO 714 intended to communicate between BOs 714 and 722 may belong to business scenario 716. In an embodiment, the business scenario 716 may belong to a particular system 710. In an embodiment, the system 710 may be a third party system and the system 720 may be an internal system. However, in another embodiment, the system 710 may be an internal system and the system 720 may be a third party system.

In an embodiment, the systems 710 and 720 may represent different software applications running on a single computer. In another embodiment, the systems 710 and 720 may represent different software applications running on separate computers such as two separate computer servers. The communication link 730 between systems 710 and 720 may include any communication protocol including hyper text transfer protocol (HTTP), file transfer protocol (FTP), and real time streaming protocol (RTSP).

In an embodiment, BO 722 may be an inbound service, i.e., a BO which receives data from another system 710. In another embodiment, BO 722 may be an outbound service. That is, data from BO 722 may flow into a BO in another system 710.

In an embodiment, the system 720 may include a BO 722 with an extension field 740. The extension field 740 belonging to BO 722 may be communicated to system 710 by sending a messages via a predefined communication protocol. For example, the value of extension field 740 belonging to BO 722 may be communicated to system 710 through one or more messages sent via HTTP 730. In an embodiment, creating a newly defined extension field 740 for a BO 722 in system 720 may expand the possible fields which can be communicated via messages from system 720 to system 710 and vice-versa. Specifically, the creation of extension field 740 for a BO 722 in system 720 may enable messages to be sent from system 720 to system 710 (and vice-versa) with values corresponding to the newly created extension field 740 in BO 722.

In an embodiment, a first system may access/modify an extension field of a BO in a second system by sending messages via a predefined communication protocol. For example, the system 710 may access/modify the value of new extension field 740 of BO 722 by sending a message via HTTP 730 to system 720. Similarly, system 720 may access/modify the values of new extension field 740 of BOs 712 and/or 714 by sending a message via HTTP 730 to system 710. In an embodiment, multiple messages may be sent back and forth between the systems 710 and 720 with information pertaining to extension fields of BOs in each system. For example, in response to a message from system 710 requesting value(s) of extension field(s) of a BO 722 in system 720, the system 720 may send a response message to system 710 with the requested value(s).

In an embodiment, a new extension field added to one BO from a particular business scenario will extend outbound/inbound messages intended to communicate between BOs from different systems. For example, after defining the new field 740 (F1) for a business scenario 716, as described above using IDE 400, BOs 712 and 714, belonging to the business scenario 716, and outbound messages belonging to business scenario 716 (such as outbound messages communicated from BO 714 and BO 722) will include the same new extension field 740. In an embodiment, the communication of the new extension field 740 may be accomplished by sending messages via a predefined communication protocol. For example, the propagation of the new extension field may be communicated from one system to another system via HTTP 730.

A person having ordinary skill in the art will appreciate that the GUIs and IDE illustrated in FIGS. 2-4 may be displayed separately or may be displayed together as part of one or more other GUIs. In an embodiment, entering information in one GUI may trigger the display of another GUI. For example, identifying business scenarios using GUI 200 may trigger the display of GUI 300. The GUIs and IDE illustrated in FIGS. 2-4 may include buttons to confirm that a particular action was taken by the user. For example, GUI 200 may include button called “search” in the search area 210 so that the user can confirm that the user intends to search for business scenarios corresponding to the search parameters. A person having ordinary skill in the art will also appreciate that the GUIs and IDE illustrated in FIGS. 2-4 don't have to be displayed in any particular order.

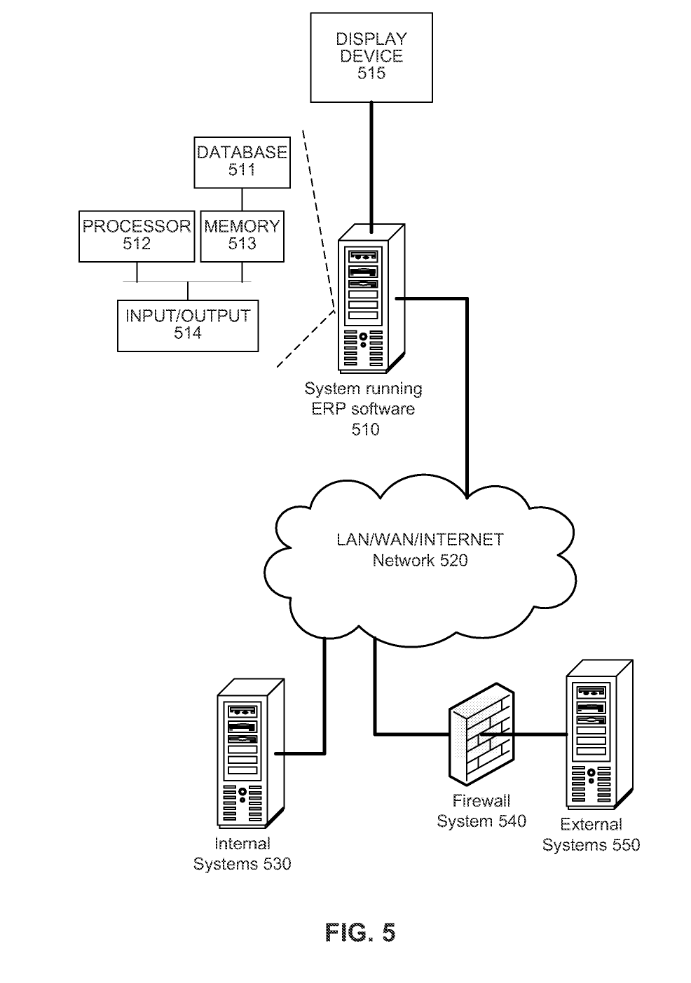

FIG. 5 shows an exemplary architecture in an embodiment of the invention. The system running an application to view, create, or modify BOs and/or business scenarios 510 may be coupled to a display device 515, existing internal systems 530 through a network 520 and to external systems 550 through the network 520 and firewall system 540. The system running an application to view, create, or modify BOs and/or business scenarios 510 may include a desktop computer, laptop computer, tablet PC, client computer, mobile phone, central computer in a vehicle, and any other computer. The display device 515 may include a computer monitor, a tablet PC screen, a mobile phone screen, and any other displays. The existing internal systems 530 may include a server and may provide business data and/or other data. The external systems 550 may include a server and may be maintained by a third party, such as an information service provider, and may contain business data and/or other data, that may be updated by the third party on a periodic basis. The system running an application to view, create, or modify BOs and/or business scenarios 510 may interact with these external systems to obtain updates through a firewall system 540 separating the internal systems from the external systems.

A person having ordinary skill in the art will appreciate that while internal systems 530 and external systems 550 are included in FIG. 5, in some embodiments, one or both of these systems may not be required. In an embodiment, the functionality provided by the internal systems 530 and external systems 550 may be provided by the system running the application to view, create, or modify BOs and/or business scenarios 510.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method to extend business scenarios comprising:
displaying an integrated development environment, wherein the integrated development environment includes functionality to add at least one extension field to business objects included in a business scenario, and at least one business object of the business objects is in a first system;
responsive to input indicating at least one extension field, adding the at least one extension field to at least one business object in the first system; and
sending a message from the first system to a second system, wherein the message includes information associated with the at least one extension field.

2. The method of claim 1, wherein the first system and second system are business software.

3. The method of claim 1, wherein the at least one business object in the first system is at least one of an inbound service and an outbound service.

4. The method of claim 1, wherein the first system and the second system communicate through a predefined protocol.

5. The method of claim 4, wherein the predefined protocol is HTTP.

6. The method of claim 1, further comprising:
responsive to the sent message, modifying a value associated with a business object in the second system.

7. An apparatus comprising:
a display to:
display an integrated development environment, wherein the integrated development environment includes functionality to add at least one extension field to business objects included in a business scenario, and at least one business object of the business objects is in a first system; and
a processor for executing computer instructions, the processor configured to:
responsive to input indicating at least one extension field, add the at least one extension field to at least one business object in the first system, and
send a message from the first system to a second system, wherein the message includes information associated with the at least one extension field.

8. The apparatus of claim 7, wherein the first system and second system are business software.

9. The apparatus of claim 7, wherein the at least one business object in the first system is at least one of an inbound service and an outbound service.

10. The apparatus of claim 7, wherein the first system and the second system communicate through a predefined protocol.

11. The apparatus of claim 10, wherein the predefined protocol is HTTP.

12. The apparatus of claim 7, wherein the processor is further configured to:
responsive to the sent message, modify a value associated with a business object in the second system.

13. A non-transitory computer-readable medium embodied with computer-executable instructions for causing a computer to execute instructions, the computer instructions comprising:
displaying an integrated development environment, wherein the integrated development environment includes functionality to add at least one extension field to business objects included in a business scenario, and at least one business object of the business objects is in a first system;
responsive to input indicating at least one extension field, adding the at least one extension field to at least one business object in the first system; and
sending a message from the first system to a second system, wherein the message includes information associated with the at least one extension field.

14. The computer-readable medium of claim 13, wherein the first system and second system are business software.

15. The computer-readable medium of claim 13, wherein the at least one business object in the first system is at least one of an inbound service and an outbound service.

16. The computer-readable medium of claim 13, wherein the first system and the second system communicate through a predefined protocol.

17. The computer-readable medium of claim 16, wherein the predefined protocol is HTTP.

18. The computer-readable medium of claim 13, further comprising:
responsive to the sent message, modifying a value associated with a business object in the second system.
